(19) United States
(12) Patent Application Publication
(10) Pub. No.: US 2009/0024518 A1
(43) Pub. Date: Jan. 22, 2009

(54) Automated system of supply and demand pairing

(76) Inventors: Alena Pavlisova, Kosice (SK); Martin Kapinos, Kosice (SK); Peter Pavlisko, Kosice (SK); Jan Pavlis, Kosice (SK); Dana Hust'akova, Kosice (SK)

Correspondence Address: DONN K. HARMS;PATENT & TRADEMARK LAW CENTER, SUITE 100, 12702 VIA CORTINA, DEL MAR, CA, 92014, US

(21) Appl. No.: 12/218,911

(22) Filed: Jul. 18, 2008

(30) Foreign Application Priority Data
Jul. 18, 2007 (SK) PUV 124-2007

(51) Int. Cl. G06Q 40/00

(52) U.S. Cl. 705/38

(57) ABSTRACT

An automated system of pairing money supply with loan demands. The system operates by pairing conformity with offered loans and their criteria with available supplies of funds. Employing networked computers with software adapted to the task, the system operates to match available funds with loan requirements for individuals and all types of business entities.

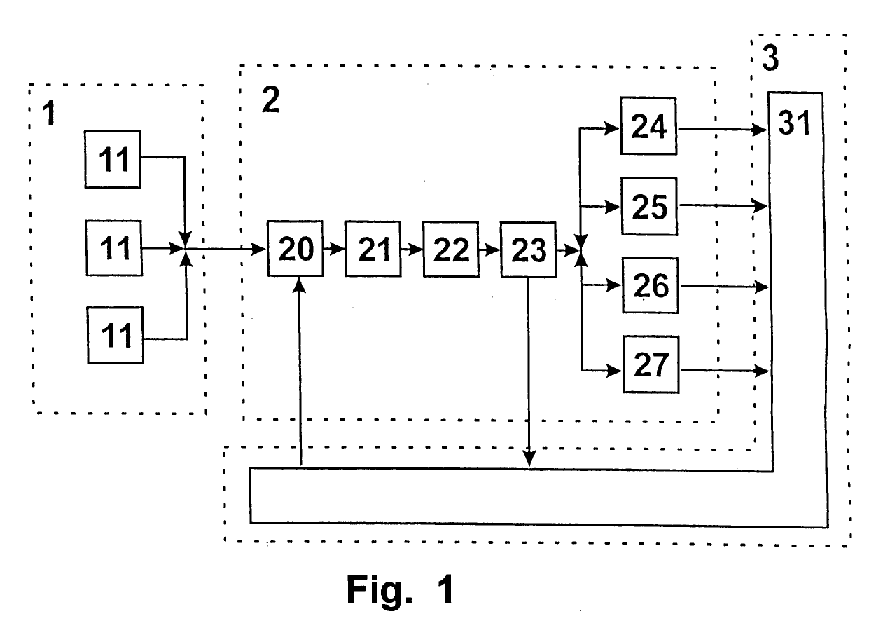

### FIELD OF TECHNOLOGY

This application claims priority to Slovakian patent application PUV 124-2007 filed on Jul. 18, 2007 and is incorporated in its entirety by reference herein. The technical solution relates to an automated system of supply and demand pairing designed mainly for searching for conformity between the supply of and demand for cash while procuring of financial loans for all types of entities on the market carried out via computer and/or internet.

### Existing State of Technology

Nowadays, financial loans are provided by banking, or nonbanking institutions. The disadvantage of such solution lies in the obligation to accept all creditor's loan conditions regardless the debtor's demand.

Another known solution comprises procurement of financial loans through a personal contact of a creditor and a debtor via an agent. The disadvantage of such solution is also the obligation to accept all creditor's loan conditions regardless the debtor's demand.

Another known technical solution is specified in a registered Slovak utility model ÚVz No. 4 730 called Connection of Electronic On-line System of Loans Market that consists of mutually on-line connected agency module, provider module, recipient module, bank module, security module, and identification-credibility module. This solution is disadvantageous because it is not usable in the field of searching for conformity between the supply of and demand for cash while procuring of financial loans.

Another known technical solution is specified in a registered Slovak utility model ÚVz No. 4 584 called Connection of Internet System of Financial Loans Procurement that is formed by mutually connected agency block, creditor block, client block, bank block and verification block that is connected via a transmission channel to at least one creditor block, and/or at least one bank block, and/or at least one agency block. This solution is disadvantageous because it is not usable in the field of searching for conformity between the supply of and demand for cash while procuring of financial loans.

Another known technical solution is specified in a registered Slovak utility model ÚVz No. 4 636 called Connection of Internet System of Financial Loans Procurement, Purchase of Goods, and Provision of Services, that is formed by mutually connected creditor block, client block, bank block, verification block, provider block, security block, external block, and agency block. This solution is disadvantageous because it is not usable in the field of searching for conformity between the supply of and demand for cash while procuring of financial loans.

Another known technical solution is specified in a registered Slovak utility model ÚVz No. 4 685 called Connection of Internet System for Verification of Client's Identity that is formed by mutually connected client block, provider block, verification block, bank block, and client block. This solution is disadvantageous because it is not usable in the field of searching for conformity between the supply of and demand for cash while procuring of financial loans.

### The Basis of a Technical Solution

The imperfections specified herein are significantly eliminated by an automated system of supply and demand pairing designed mainly for searching for conformity between the supply of and demand for cash while procuring of financial loans for all types of entities on the market carried out via computer and/or internet, according to a technical solution based on the fact that at least one provider module formed by at least one cash provider is connected to at least one demand module formed by at least one cash applicant through at least one input length-loan block of at least one pairing criterion module that is connected to at least one interest-intersection block that is connected to at least one minimum-parameter block that is connected to at least one loan-share block that is connected to demand module from one side and from the other side to at least one credibility block, and/or at least one interest-rate block, and/or at least one distribution block, and/or at least one time-direction block. It is advantageous that at least one credibility block is connected to at least one cash applicant of a demand module from one side and from the other side to at least one interest-rate block, and/or at least one distribution block, and/or at least one time-direction block.

It is advantageous that at least one interest-rate block is connected to at least one cash applicant of a demand module from one side and from the other side to at least one decision block, and/or at least one time-direction block.

It is advantageous that at least one decision block is connected to at least one cash applicant of a demand module from one side and from the other side to at least one time-direction block.

It is advantageous that at least one cash applicant enters from one side into the input length-loan block one demand formed by a requested minimum length of a loan and a sum and a maximum amount of interest, and from the other side at least one cash provider enters into the input length-loan block at least one offer as a credibility requirement and an offered maximum length of a loan and a sum and a minimum amount of interest.

It is advantageous that at least one input length-loan block, by a criterion for length of loans, shall find conformity of a length of loan of all offers and a length of loan of demand by pairing.

It is advantageous that at least one interest-intersection block, by a criterion for interest intersections, shall find conformity of interest rate of all offers and interest rate of demand by pairing.

It is advantageous that at least one minimum-parameter block, by a criterion for minimum parameter, shall find conformity of minimum number of offers and one demand by pairing.

It is advantageous that a loan-share block, by a criterion for a share in a loan, shall find conformity of a limited loaned amount of one offer and one demand by pairing.

It is advantageous that a credibility block, by a criterion for credibility requirement, shall find conformity of all offers and demand by pairing.

It is advantageous that an interest-rate block, by a criterion for the lowest offered interest rate, shall prefer the sum of the offer with the lowest amount of interest to the sum of the offer with a higher amount of interest by pairing.

It is advantageous that a distribution block, by a criterion for an even distribution, shall find conformity of the final part of distribution of the loaned amount of offers and one demand by pairing.

It is advantageous that a time-direction block, by a criterion for an offer set earlier, shall prefer the offered sum of the earlier offer to the amount of the later offer by pairing.

It is advantageous that a pairing criterion module determines to a cash applicant an interest rate as a weighted arithmetic mean of interest rates of at least one cash provider.

It is advantageous that a pairing criterion module determines to a cash provider an interest rate as an arithmetic mean of interest rates of a cash applicant and a cash provider.

It is advantageous that a pairing criterion module determines the amount of a loaned sum to a cash applicant reduced by an advance payment for possible costs of claim enforcement, and/or reduced by a commission for the system operator, and/or security over repaying of a loan.

### OVERVIEW OF THE PICTURES IN THE DRAWING

Technical solution shall be explained in details by pictures, picture No. 1 shows a schematic illustration of a basic block scheme of connection of an automated system of supply and demand pairing.

### EXAMPLES OF IMPLEMENTATION

### Example No. 1

An automated system of supply and demand pairing designed mainly for searching for conformity between the supply of and demand for cash while procuring of financial loans for all types of entities on the market carried out via computer and/or internet, according to picture No. 1, is formed by one provider module 1 that is formed by one cash provider 11 that is connected from one side to the input length-loan block 20 in the pairing criterion module 2 that is designed for entering offers with the term for one year and entering offers comprising the amount of a sum and a minimum interest rate in the amount of 15%. The input length-loan block 20 is connected from the other side to one demand module 3 that is formed by one cash applicant 31 while the requested length of a loan is 1 year and the requested amount of the sum and the maximum interest rate is in the amount of 15%. The input length-loan block 20 shall find the number of one offer from the cash provider 11 who meets the requested one-year term of a loan. The input length-loan block 20 is connected from another side to the interest-intersection block 21 that shall find the number of one offer from a cash provider 11 that meets the requested interest rate in the amount of 15% of one cash applicant 31. The interest-intersection block 21 is connected to the minimum-parameter block 22 that shall pair one cash provider 11 with one cash applicant 31 on the basis of a preset parameter as a minimum number of cash providers 11 who shall pay one cash applicant 21. The minimum-parameter block 22 is connected to the loan-share block 23 that shall pair one cash provider 11 with one cash applicant 31 on the basis of a preset parameter as a limited minimum and maximum amount of a loaned sum of one cash provider 11 for payment of one cash applicant 31.

### Example No. 2

An automated system of supply and demand pairing designed mainly for searching for conformity between the supply of and demand for cash while procuring of financial loans for all types of entities on the market carried out via computer and/or internet, according to picture No. 1, is formed by one provider module 1 that is formed by six cash providers 11 that is connected from one side to the input length-loan block 20 in the pairing criterion module 2 that is designed for entering an offer for the term of a loan and offers for the sum and the minimum amount of interest rate. The provider module 1 is formed by the first cash provider 11 with the requested minimum interest rate in the amount of 11% and the term of loan for 1 year. The provider module 1 is formed by the second cash provider 11 with the requested minimum interest rate in the amount of 12% and the term of loan for 1 year. The provider module 1 is formed by the third cash provider 11 with the requested minimum interest rate in the amount of 13% and the term of loan for 1 year. The provider module 1 is formed by the fourth cash provider 11 with the requested minimum interest rate in the amount of 14% and the term of loan for 1 year. The provider module 1 is formed by the fifth cash provider 11 with the requested minimum interest rate in the amount of 15% and the term of loan for 1 year. The provider module 1 is formed by the sixth cash provider 11 with the requested minimum interest rate in the amount of 16% and the term of loan for 1 year. The input length-loan block 20 is connected from the other side to one demand module 3 that is formed by one cash applicant 31 while the requested term of a loan is 1 year and the requested amount of the sum and the maximum interest rate is in the amount of 15%. The input length-loan block 20 shall find the number of six offers from cash providers 11 who meet the requested one-year term of a loan. The input length-loan block 20 is connected from another side to the interest-intersection block 21 that shall find the number of five offers from cash providers 11 who by their interest rate up to 15%, including, meet the requested interest rate in the amount of 15% of one cash applicant 31. The interest-intersection block 21 shall eliminate the sixth cash provider 11 who by its interest rate of 16% does not comply with the requested interest rate in the amount of 15% of one cash applicant 31. The interest-intersection block 21 is connected to the minimum-parameter block 22 that shall pair the first cash provider 11 with one cash applicant 31 on the basis of a preset parameter as a minimum number of cash providers 11 who shall pay one cash applicant 21. The interest-intersection block 21 is connected to the minimum-parameter block 22 that shall pair the second cash provider 11 with one cash applicant 31 on the basis of a preset parameter as a minimum number of cash providers 11 who shall pay one cash applicant 21. The interest-intersection block 21 is connected to the minimum-parameter block 22 that shall pair the third cash provider 11 with one cash applicant 31 on the basis of a preset parameter as a minimum number of cash providers 11 who shall pay one cash applicant 21. The interest-intersection block 21 is connected to the minimum-parameter block 22 that shall pair the fourth cash provider 11 with one cash applicant 31 on the basis of a preset parameter as a minimum number of cash providers 11 who shall pay one cash applicant 21. The interest-intersection block 21 is connected to the minimum-parameter block 22 that shall pair the fifth cash provider 11 with one cash applicant 31 on the basis of a preset parameter as a minimum number of cash providers 11 who shall pay one cash applicant 21. The minimum-parameter block 22 is connected to the loan-share block 23 that shall pair five cash providers 11 with one cash applicant 31 on the basis of a preset parameter as a limited minimum and maximum amount of a loaned sum of one cash provider 11 for payment of one cash applicant 31. The loan-share block 23 is connected to the credibility block 24 that shall find by pairing under the criterion for credibility requirement conformity of all offers and demand. The loan-share block 23 is connected to the distribution block 26 that shall pair five cash providers 11 with one cash applicant 31 on the basis of a preset parameter as an even distribution of the final amount for distribution among five cash providers 11 to satisfy one cash applicant's demand 31. The cash applicant 31 shall obtain interest rate consisting of the weighted arithmetic average of the interest rate 11% of the first cash provider 11, interest rate 12% of the second cash provider 11, interest rate 13% of the third cash provider 11, interest rate 14% of the fourth cash provider 11, interest rate 15% of the fifth cash provider 11.

### Example No. 3

An automated system of supply and demand pairing designed mainly for searching for conformity between the supply of and demand for cash while procuring of financial loans for all types of entities on the market carried out via computer and/or internet, according to picture No. 1, is formed by one provider module 1 that is formed by six cash providers 11 that is connected from one side to the input length-loan block 20 in the pairing criterion module 2 that is designed for entering an offer for the term of a loan and offers for the sum and the minimum amount of interest rate. The provider module 1 is formed by the first cash provider 11 with the requested minimum interest rate in the amount of 11% and the term of loan for 1 year. The provider module 1 is formed by the second cash provider 11 with the requested minimum interest rate in the amount of 12% and the term of loan for 1 year. The provider module 1 is formed by the third cash provider 11 with the requested minimum interest rate in the amount of 13% and the term of loan for 1 year. The provider module 1 is formed by the fourth cash provider 11 with the requested minimum interest rate in the amount of 14% and the term of loan for 1 year. The provider module 1 is formed by the fifth cash provider 11 with the requested minimum interest rate in the amount of 15% and the term of loan for 1 year. The provider module 1 is formed by the sixth cash provider 11 with the requested minimum interest rate in the amount of 16% and the term of loan for 1 year. The input length-loan block 20 is connected from the other side to one demand module 3 that is formed by one cash applicant 31 while the requested term of a loan is 1 year and the requested amount of the sum and the maximum interest rate is in the amount of 15%. The input length-loan block 20 shall find the number of six offers from cash providers 11 who meet the requested one-year term of a loan. The input length-loan block 20 is connected from another side to the interest-intersection block 21 that shall find the number of five offers from cash providers 11 who by their interest rate up to 15%, including, meet the requested interest rate in the amount of 15% of one cash applicant 31. The interest-intersection block 21 shall eliminate the sixth cash provider 11 who by its interest rate of 16% does not comply with the requested interest rate in the amount of 15% of one cash applicant 31. The interest-intersection block 21 is connected to the minimum-parameter block 22 that shall pair the first cash provider 11 with one cash applicant 31 on the basis of a preset parameter as a minimum number of cash providers 11 who shall pay one cash applicant 21. The interest-intersection block 21 is connected to the minimum-parameter block 22 that shall pair the second cash provider 11 with one cash applicant 31 on the basis of a preset parameter as a minimum number of cash providers 11 who shall pay one cash applicant 21. The interest-intersection block 21 is connected to the minimum-parameter block 22 that shall pair the third cash provider 11 with one cash applicant 31 on the basis of a preset parameter as a minimum number of cash providers 11 who shall pay one cash applicant 21. The interest-intersection block 21 is connected to the minimum-parameter block 22 that shall pair the fourth cash provider 11 with one cash applicant 31 on the basis of a preset parameter as a minimum number of cash providers 11 who shall pay one cash applicant 21. The interest-intersection block 21 is connected to the minimum-parameter block 22 that shall pair the fifth cash provider 11 with one cash applicant 31 on the basis of a preset parameter as a minimum number of cash providers 11 who shall pay one cash applicant 21. The minimum-parameter block 22 is connected to the loan-share block 23 that shall pair five cash providers 11 with one cash applicant 31 on the basis of a preset parameter as a limited minimum and maximum amount of a loaned sum of one cash provider 11 for payment of one cash applicant 31. The loan-share block 23 is connected to the credibility block 24 that shall find by pairing under the criterion for credibility requirement conformity of all offers and demand. The loan-share block 23 is connected to the distribution block 26 that shall pair five cash providers 11 with one cash applicant 31 on the basis of a preset parameter as an even distribution of the final amount for distribution among five cash providers 11 to satisfy one cash applicant□s demand 31. The cash applicant 31 shall obtain interest rate consisting of the weighted arithmetic average of the interest rate 11% of the first cash provider 11, interest rate 12% of the second cash provider 11, interest rate 13% of the third cash provider 11, interest rate 14% of the fourth cash provider 11, interest rate 15% of the fifth cash provider 11. The loan-share block 23 is connected to the credibility block 24 that shall find by pairing under the criterion for credibility requirement conformity of all offers and demand. The loan-share block 23 is connected to the distribution block 26 that shall pair five cash providers 11 with one cash applicant 31 on the basis of a preset parameter as an even distribution of the final amount for distribution among five cash providers 11 to satisfy one cash applicant's demand 31. The distribution block 26 is connected to the interest-rate block 26 that shall prefer the offered amount of the sum from the cash provider 11 with the lowest offered amount of the interest rate. The cash applicant 31 shall obtain interest rate consisting of the weighted arithmetic average of the interest rate 11% of the first cash provider 11, interest rate 12% of the second cash provider 11, interest rate 13% of the third cash provider 11, interest rate 14% of the fourth cash provider 11, and interest rate 15% of the fifth cash provider 11.

### Example No. 4

An automated system of supply and demand pairing designed mainly for searching for conformity between the supply of and demand for cash while procuring of financial loans for all types of entities on the market carried out via computer and/or internet, according to picture No. 1, is formed by one provider module 1 that is formed by six cash providers 11 that is connected from one side to the input length-loan block 20 in the pairing criterion module 2 that is designed for entering an offer for the term of a loan and offers for the sum and the minimum amount of interest rate. The provider module 1 is formed by the first cash provider 11 with the requested minimum interest rate in the amount of 11% and the term of loan for 1 year. The provider module 1 is formed by the second cash provider 11 with the requested minimum interest rate in the amount of 12% and the term of loan for 1 year. The provider module 1 is formed by the third cash provider 11 with the requested minimum interest rate in the amount of 13% and the term of loan for 1 year. The provider module 1 is formed by the fourth cash provider 11 with the requested minimum interest rate in the amount of 14% and the term of loan for 1 year. The provider module 1 is formed by the fifth cash provider 11 with the requested minimum interest rate in the amount of 15% and the term of loan for 1 year. The provider module 1 is formed by the sixth cash provider 11 with the requested minimum interest rate in the amount of 16% and the term of loan for 1 year. The input length-loan block 20 is connected from the other side to one demand module 3 that is formed by one cash applicant 31 while the requested term of a loan is 1 year and the requested amount of the sum and the maximum interest rate is in the amount of 15%. The input length-loan block 20 shall find the number of six offers from cash providers 11 who meet the requested one-year term of a loan. The input length-loan block 20 is connected from another side to the interest-intersection block 21 that shall find the number of five offers from cash providers 11 who by their interest rate up to 15%, including, meet the requested interest-rate in the amount of 15% of one cash applicant 31. The interest-intersection block 21 shall eliminate the sixth cash provider 11 who by its interest rate of 16% does not comply with the requested interest rate in the amount of 15% of one cash applicant 31. The interest-intersection block 21 is connected to the minimum-parameter block 22 that shall pair the first cash provider 11 with one cash applicant 31 on the basis of a preset parameter as a minimum number of cash providers 11 who shall pay one cash applicant 21. The interest-intersection block 21 is connected to the minimum-parameter block 22 that shall pair the second cash provider 11 with one cash applicant 31 on the basis of a preset parameter as a minimum number of cash providers 11 who shall pay one cash applicant 21. The interest-intersection block 21 is connected to the minimum-parameter block 22 that shall pair the third cash provider 11 with one cash applicant 31 on the basis of a preset parameter as a minimum number of cash providers 11 who shall pay one cash applicant 21. The interest-intersection block 21 is connected to the minimum-parameter block 22 that shall pair the fourth cash provider 11 with one cash applicant 31 on the basis of a preset parameter as a minimum number of cash providers 11 who shall pay one cash applicant 21. The interest-intersection block 21 is connected to the minimum-parameter block 22 that shall pair the fifth cash provider 11 with one cash applicant 31 on the basis of a preset parameter as a minimum number of cash providers 11 who shall pay one cash applicant 21. The minimum-parameter block 22 is connected to the loan-share block 23 that shall pair five cash providers 11 with one cash applicant 31 on the basis of a preset parameter as a limited minimum and maximum amount of a loaned sum of one cash provider 11 for payment of one cash applicant 31. The loan-share block 23 is connected to the credibility block 24 that shall find by pairing under the criterion for credibility requirement conformity of all offers and demand. The loan-share block 23 is connected to the distribution block 26 that shall pair five cash providers 11 with one cash applicant 31 on the basis of a preset parameter as an even distribution of the final amount for distribution among five cash providers 11 to satisfy one cash applicant's demand 31. The cash applicant 31 shall obtain interest rate consisting of the weighted arithmetic average of the interest rate 11% of the first cash provider 11, interest rate 12% of the second cash provider 11, interest rate 13% of the third cash provider 11, interest rate 14% of the fourth cash provider 11, interest rate 15% of the fifth cash provider 11. The loan-share block 23 is connected to the credibility block 24 that shall find by pairing under the criterion for credibility requirement conformity of all offers and demand. The loan-share block 23 is connected to the distribution block 26 that shall pair five cash providers 11 with one cash applicant 31 on the basis of a preset parameter as an even distribution of the final amount for distribution among five cash providers 11 to satisfy one cash applicant's demand 31. The distribution block 26 is connected to the time-direction block 26 that shall prefer the offered amount of the cash provider 11 with the amount of the interest rate offered earlier.

### Industrial Usability

An automated system of supply and demand pairing designed mainly for searching for conformity between the supply of and demand for cash while procuring of financial loans for all types of entities on the market carried out via computer and/or internet, according to the technical solution, may be used in the field of electronic money market, for the purpose of development of loans availability for purchase of services and goods for natural persons or legal entities, as well as for the purpose of reaching better interest on available resources for natural persons or legal entities that shall result in profit on both sides, because the cost of money for a loan applicant shall be lower, and interest on the provider's available money shall be higher.

What is claimed is:

1. An automated system of supply and demand pairing designed mainly for searching for conformity between the supply of and demand for cash while procuring of financial loans for all types of entities on the market carried out via computer and/or internet, characteristic for the fact that at least one provider module (1) formed by at least one cash provider (11) is connected to at least one demand module (3) formed by at least one cash applicant (31) through at least one input length-loan block (20) of at least one pairing criterion module (2) that is connected to at least one interest-intersection block (21) that is connected to at least one minimum-parameter block (22) that is connected to at least one loan-share block (23) that is connected to the demand module (3) from one side and from the other side to at least one credibility block (24), and/or at least one interest-rate block (25), and/or at least one distribution block (26), and/or at least one time-direction block (27).

2. An automated system of supply and demand pairing, according to requirement 1, characteristic for the fact that at least one credibility block (24) is connected to at least one cash applicant (31) of the demand module (3) from one side, and from the other side to at least one interest-rate block (25), and/or to at least one distribution block (26), and/or to at least one time-direction block (27).

3. An automated system of supply and demand pairing, according to requirements 1 and 2, characteristic for the fact that at least one interest-rate block (25) is connected to at least one cash applicant (31) of the demand module (3) from one side, and from the other side to at least one decision block (26), and/or to at least one time-direction block (27).

4. An automated system of supply and demand pairing, according to requirements 1 to 3, characteristic for the fact that at least one decision block (26) is connected to at least one cash applicant (31) of the demand module (3) from one side, and from the other side to at least one time-direction block (27).

5. An automated system of supply and demand pairing, according to requirements 1 to 4, characteristic for the fact that at least one cash applicant (31) enters from one side into the input length-loan block (20) one demand comprising the requested term of a loan, the amount of the sum and the maximum amount of the interest, and at least one cash provider (11) enters from the other side into the input length-loan block (20) at least one offer as a credibility requirement and the offered maximum term of a loan, the amount of the sum and the minimum amount of the interest.

6. An automated system of supply and demand pairing, according to requirement 5, characteristic for the fact that at least one input length-loan block (20), by a criterion for length of loans, shall find conformity of a length of loan of all offers and a length of loan of demand by pairing.

7. An automated system of supply and demand pairing, according to requirements 5 and 6, characteristic for the fact that at least one interest-intersection block (21), by a criterion for interest intersections, shall find conformity of interest rate of all offers and interest rate of demand by pairing.

8. An automated system of supply and demand pairing, according to requirements 5 to 7, characteristic for the fact that at least one minimum-parameter block (22), by a criterion for minimum parameter, shall find conformity of minimum number of offers and one demand.

9. An automated system of supply and demand pairing, according to requirements 5 to 8, characteristic for the fact that a loan-share block (23), by a criterion for a share in a loan, shall find conformity of a limited loaned amount of one offer and one demand by pairing.

10. An automated system of supply and demand pairing, according to requirements 5 to 9, characteristic for the fact that a credibility block (24), by a criterion for credibility requirement, shall find conformity of all offers and demand by pairing.

11. An automated system of supply and demand pairing, according to requirements 5 to 10, characteristic for the fact that an interest-rate block (25), by a criterion for the lowest offered interest rate, shall prefer the sum of the offer with the lowest amount of interest to the sum of the offer with a higher amount of interest by pairing.

12. An automated system of supply and demand pairing, according to requirements 5 to 11, characteristic for the fact that a distribution block (26), by a criterion for an even distribution, shall find conformity of the final part of distribution of the loaned amount of offers and one demand by pairing.

13. An automated system of supply and demand pairing, according to requirements 5 to 12, characteristic for the fact that a time-direction block (27), by a criterion for an offer set earlier, shall prefer the offered sum of the earlier offer to the amount of the later offer by pairing.

14. An automated system of supply and demand pairing, according to requirements 5 to 13, characteristic for the fact that a pairing criterion module (2) determines to a cash applicant (31) an interest rate as a weighted arithmetic mean of interest rates of at least one cash provider (11).

15. An automated system of supply and demand pairing, according to requirement 14, characteristic for the fact that a pairing criterion module (2) determines to a cash provider (11) an interest rate as an arithmetic mean of interest rates of a cash applicant (31) and a cash provider (11).

16. An automated system of supply and demand pairing, according to requirements 1 to 15, characteristic for the fact that a pairing criterion module (2) determines the amount of a loaned sum to a cash applicant (31) reduced by an advance payment for possible costs of claim enforcement, and/or reduced by a commission for the system operator, and/or security over repaying of a loan.
